(19) United States
(12) Patent Application Publication
(10) Pub. No.: US 2023/0100051 A1
(43) Pub. Date: Mar. 30, 2023

(54) METHODS AND APPARATUS TO SERVICE WORKLOADS LOCALLY AT A COMPUTING DEVICE

(71) Applicant: Intel Corporation, Santa Clara, CA (US)

(72) Inventors: Gautam Singh, Morrisville, NC (US); Curtis Jutzi, Lake Oswego, OR (US); Mousumi Hazra, Vancouver, WA (US); Patrick Kutch, Tigard, OR (US); Anand Rangarajan, Portland, OR (US); Arvind Kumar, Beaverton, OR (US); Garritt Binder, Loomis, CA (US)

(21) Appl. No.: 18/076,366

(22) Filed: Dec. 6, 2022

(51) Int. Cl. H04L 67/1012; H04L 67/1008; H04L 67/146

(52) U.S. Cl. CPC H04L 67/1012; H04L 67/1008; H04L 67/146

(57) ABSTRACT

Methods, apparatus, systems, and articles of manufacture to service workloads locally at a computing device are disclosed. An example apparatus includes processor circuitry to instantiate application circuitry to, after determining that the container is locally available to execute the workload, transmit an application programming interface (API) call to local API gateway circuitry using a system local network stack Internet protocol (IP) address; the local API gateway circuitry to identify service container circuitry to execute the workload based on the API call; and the service container circuitry to utilize the container to execute the workload to generate an output; and the local API gateway circuitry to forward the output to the application circuitry.

### FIELD OF THE DISCLOSURE

This disclosure relates generally to computing devices and, more particularly, to methods and apparatus to service workloads locally at a computing device.

### BACKGROUND

In recent years, cloud-based services have increased in popularity to allow computing devices in the cloud to process workloads for a computing device outside of the cloud. For example, tasks that require a large amount of resources may be transmitted from a local computing device to the cloud to be executed by devices in the cloud. In this manner, the cloud can return the result of the workload to the computing device, thereby saving resources of the local computing device.

### BRIEF DESCRIPTION OF THE DRAWINGS

FIG. 1 is an example environment for executing one or more workloads described in conjunction with examples disclosed herein.

FIG. 2 is a block diagram of an example computing device of FIG. 1.

FIG. 3 is a flowchart representative of example machine readable instructions and/or example operations that may be executed by example processor circuitry to implement the computing device of FIG. 2.

FIG. 4 is a block diagram of an example processing platform including processor circuitry structured to execute the example machine readable instructions and/or the example operations of FIG. 3 to implement the computing device of FIG. 2.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Although cloud systems can execute workloads for a computing device to save resources of the computing device and/or to execute workloads that the computing device may not have capacity and/or capability to execute. Particular workloads may be better suited to be processed locally at the computing device. For example, a user may want a workload that is to operate on particular data to remain local (e.g., be executed locally) and to not be sent to the cloud for privacy and/or security reasons. In some examples, transmitting workloads to the cloud may increase delay and/or increase cost of execution of the workloads due to network latency, reducing compute, network and/or storage costs, etc.

To avoid sending particular workloads to the cloud for execution, some techniques allow a local computing device to execute workload and/or portion(s) of a workload locally. For example, if a computing device has the capability and/or capacity to perform speech-to-text conversion locally, the computing device may start to perform the speech-to-text conversion locally instead of sending data to the cloud to perform the speech-to-text conversion. If the computing device determines that the speech-to-text conversion is taking up too many resources and/or is causing issues, the speech-to-text conversion workload can be automatically transferred to the cloud with or without intervention from an end user of the computing device.

Cloud services utilize a cloud API gateway to function as a interface between the end user devices and the cloud-based devices (e.g., to obtain workloads and provide the results of the workload execution). The cloud API gateway performs secure request termination to ensure that a workload is obtained, executed, and a result is returned, provides cross-origin resource sharing (CORS) support for cross-origin requests, performs metering of data to/from the end user devices from/to the cloud, performs authentication and authorization of end user devices to the cloud-based servers, and provides logging to track that amount of cloud resources spent. CORS is a HTTP header based mechanism used by a server to indicate any origins from which a browser should allow the loading of resources. CORS can also submit an initial request (e.g., including headers that indicate a HTTP method and headers that will be used in the request) to a server hosing a cross-origin resource to verify that the service will allow request(s).

For local execution of workloads in a computing device, an application running on the computing device (e.g., a software as a service (SaaS) application) needs a way to securely invoke representational state transfer (REST) APIs that are hosted in local containers. Traditionally, when an application uses a browser of a computing device attempt to execute a portion of a workload locally, the browser computing device hosts certificates for a requested API domain to be certified by a certificate authority (CA) for a transport layer security (TLS) session to be established using private key(s) and/or token(s). However, such traditional techniques are costly and complex. Additionally, such traditional techniques invoke a risk of a private key being stolen, sniffed, and/or intercepted by a third party (e.g., a malicious entity). Accordingly, examples disclosed herein provide a local API gateway that facilitates a security scheme for secure access of APIs that are service by local containers implemented in a computing device to execute workloads locally without the use of a traditional TLS session. By implementing a local API gateway, a browser of a computing device can transmit workload requests to local containers of the computing device, via the local API gateway, without the use of a TLS session by leveraging calls to a system local network stack (e.g., a localhost, a URL corresponding to a localhost IP address, etc.). Examples disclosed herein reduce cost, reduce complexity, and increase security for local workload execution. Additionally, the example local API gateway described herein can be used to perform local metering, logging, and/or authentication and authorization decisions.

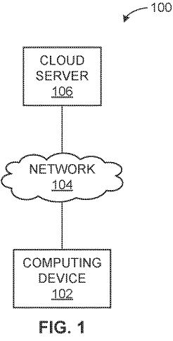

FIG. 1 is an example environment 100 for implementing workloads locally and/or using cloud-based resources. The example environment 100 includes an example computing device 102, an example network 104, and an example cloud server 106 (e.g., also referred to as a cloud-based server). Although the example of FIG. 1 includes a single cloud server 106, the cloud server 106 can be any number of cloud-based devices and/or resources to implement a cloud environment.

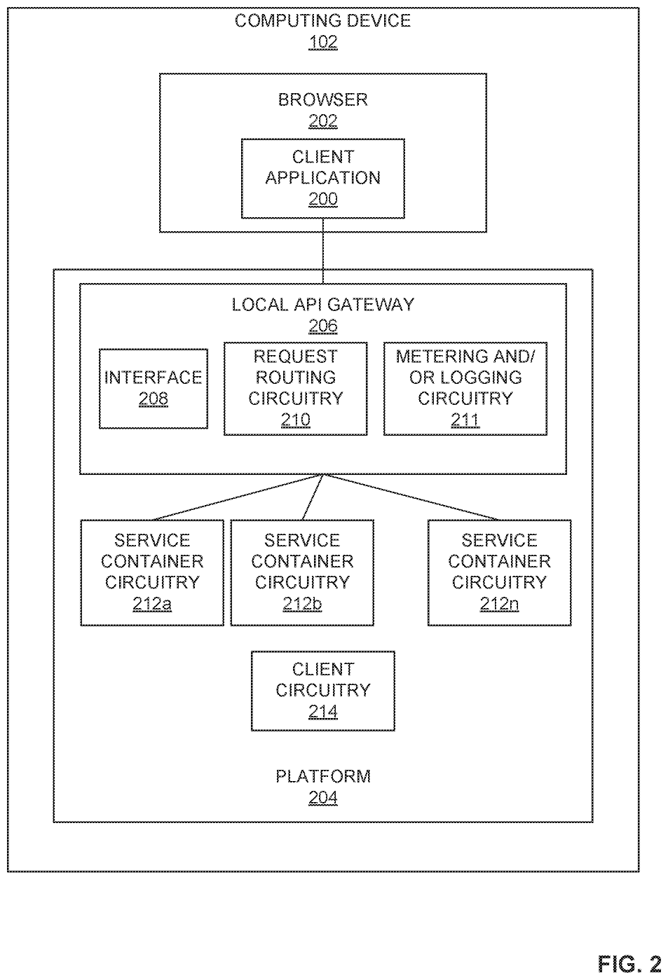

The example computing device 102 of FIG. 1 is a device capable of executing instructions to locally execute one or more workloads (e.g., cloud-based workloads that are scheduled to be executed in the cloud) and/or transmit one or more workloads to the example cloud server 106 (e.g., via the network 104) to be executed by the cloud server 106. The example computing device 102 may be a server, a processing device, a mobile device (e.g., a tablet, a smartphone, etc.), a personal computer, an edge device, a fog device, a client device, a smart device (e.g., smart phone, smart appliance, etc.), and/or any other computing device capable of executing instructions. The example computing device 102 may implement a browser to make API calls to the cloud server 106 and/or to local containers to execute workload(s) and/or portion(s) of workloads externally (e.g., at the cloud server 106) and/or locally (e.g., at the computing device 102). The example computing device 102 includes a local API gateway to act as a gateway to local containers, secure request termination for local execution of workloads, provide CORS support, meter and/or log local workload execution information, and/or perform authentication and authorization. The example computing device 102 is further described below, in conjunction with FIG. 2.

The example network 104 of FIG. 1 is a system of interconnected systems exchanging data. The example network 104 may be implemented using any type of public or private network such as, but not limited to, the Internet, a telephone network, a local area network (LAN), a cable network, and/or a wireless network. To enable communication via the network 104, the example computing device 102 includes a communication interface that enables a connection to an Ethernet, a digital subscriber line (DSL), a telephone line, a coaxial cable, any wireless connection or communication, any network communication, etc. In some examples, the example computing device 102 and the example cloud server 106 are connected via the example network 104.

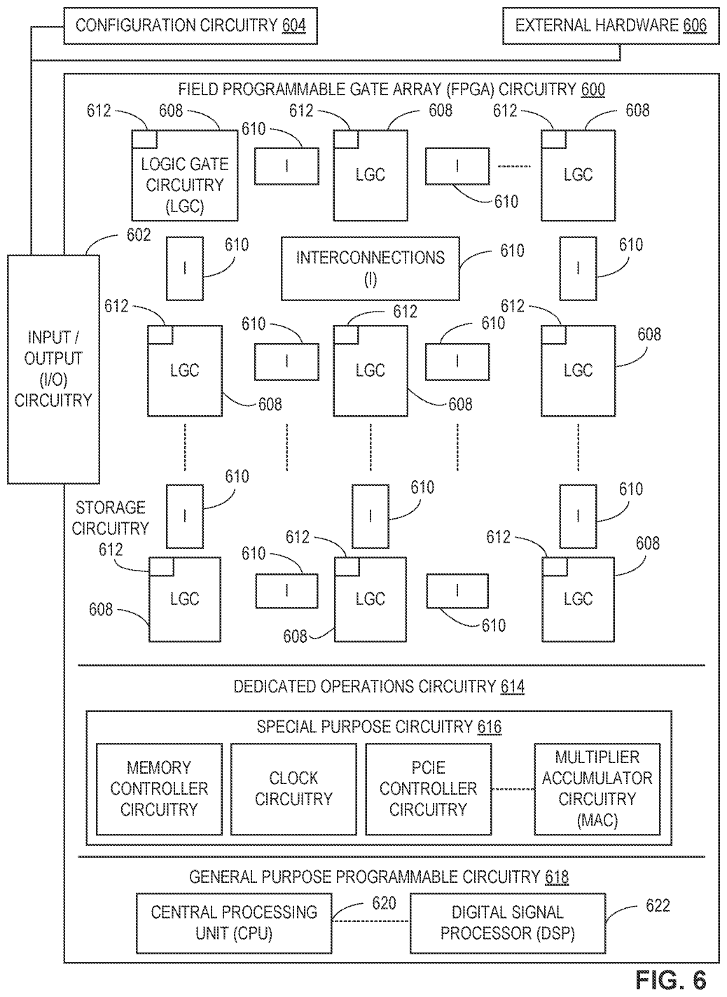

The example cloud server 106 of FIG. 6 corresponds to cloud-based services for the example computing device 102. For example, the cloud server 106 may be a computing device(s), a server(s), a processing resource(s), a memory resource(s), storage, etc. that is implemented by a cloud service provider. In some examples, the cloud server 106 may include multiple servers and/or devices. The cloud server 106 receives client application requests, token (e.g., also referred to as a key) requests, workload execution requests, etc. from the computing device 102. The cloud server 106 can transmit responses to the client application request and/or token requests, execute the workload, and/or transmit a result of a workload execution. The client application and/or token requests are requests for a token(s) (e.g., using a valid user name and/or password) for a REST service. After the cloud server 106 transmits a token, the computing device 102 uses the token with each subsequent request.

FIG. 2 is a block diagram of the example computing device 102 of FIG. 1. The computing device 102 of FIG. 2 may be instantiated (e.g., creating an instance of, bring into being for any length of time, materialize, implement, etc.) by processor circuitry such as a central processing unit executing instructions. Additionally or alternatively, the computing device 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers. The example computing device 102 of FIG. 2 includes an example client application 200 and an example platform 204. In the example of FIG. 2, the example client application 200 runs within the browser 202. However, the client application 200 may be running as a device agent/native application alongside the example browser 202. The example platform 204 includes an example local API gateway 206, example service container circuitry 212a, and example client circuitry 214. The example local API gateway 206 includes an example interface 208, example request routing circuitry 210, and example metering and/or logging circuitry 211.

The example client application 200 of FIG. 2 (e.g., also referred to as client application circuitry or client application software) is an application (e.g., a user interface (UI) application, a native application, etc.) that invokes one or more REST APIs to have a workload executed locally and/or at the cloud server 106 using requests to one or more IP addresses via the example browser using an URL. In some examples, the client application 200 is a SaaS client. The example client application 200 may transmit client application requests and/or token requests to the example cloud server 106 using credentials. After a token has been established, the client application 200 can make API calls to the cloud server 106 to execute a workload and/or a portion of a workload. If the client application 200 determines that a workload and/or a portion of a workload should be executed locally, the example client application 200 transmits an inquiry (e.g., via an API call using the browser 202) to the example client circuitry 214 to determine if container orchestration is available (e.g., if a container is available to execute the workload or portion). The client application 200 may determine that a workload or portion of the workload should be executed locally based on (a) the resources needed to execute the workload, (b) the type of data associated with the workload (e.g., if the data is provided, sensitive, etc.), (c) the resources available at the computing device 102, and/or (d) user and/or manufacturer preferences. The example client application 200 determines whether the container orchestration is available based on a response from the example client circuitry 214. If the container orchestration is unavailable, the example client application 200 may utilize the browser 202 to make API requests to the example cloud server 106 or may wait until container orchestration is available. If the client application 200 makes API request to the example cloud server 106 initially, the example client application 200 may submit additional inquiries (e.g., after a threshold amount of time) to the example client circuitry 214 to determine if container orchestration has become available.

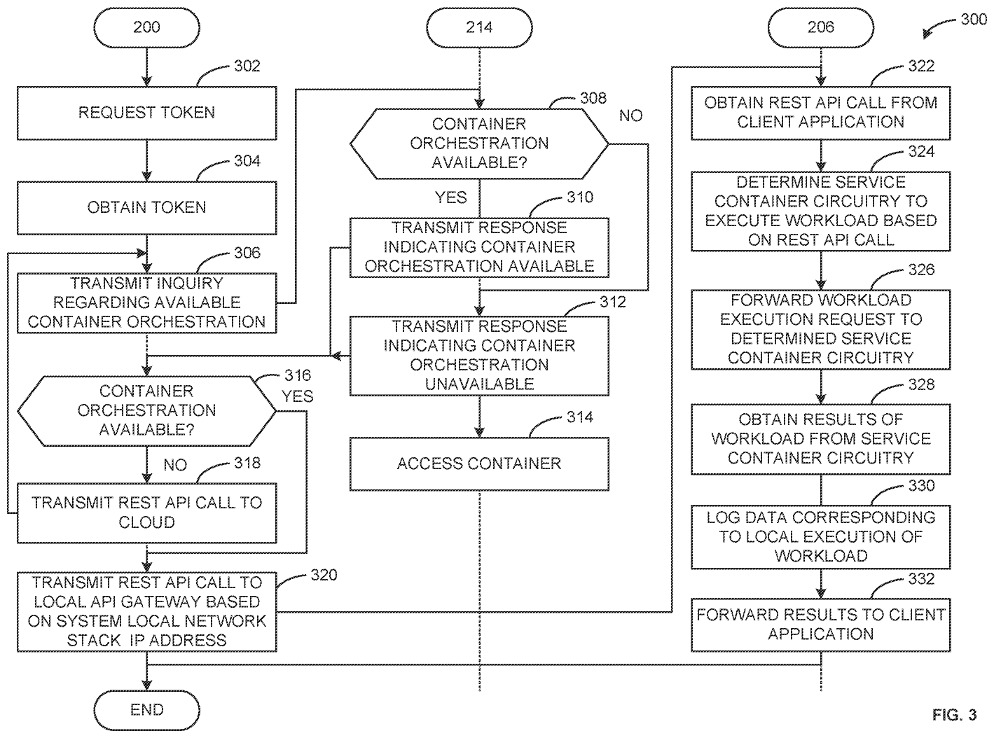

If the container orchestration is available (e.g., service container circuitry is available to execute the workload or the portion of the workload), the example client application 200 of FIG. 2 utilizes the browser 202 to make an API call to the local API gateway 206 using a URL that identifies a system local network stack (e.g., localhost) IP address. A system local network stack IP address (e.g., a localhost, 127.0.0.1, 127.0.0.0/8, etc.) is considered a trustworthy endpoint because traffic on a system local network stack IP address cannot be sniffed and traffic sent on a system local network stack IP address is guaranteed to not leave the computing device 102. Accordingly, a utilization of system local network stack IP address is very secure against any sort of network interception. The client application 200 uses the browser 202 to transmit API requests to execute a workload or portion over the system local network stack IP address (e.g., using a URL) to the example local API gateway 216 of the platform 204. By leveraging the system local network stack IP address, the client application 200 can transmit API requests for workload execution without using a TLS protocol, thereby corresponding to a less complex, less costly, more secure protocol for executing workloads locally. In some examples, the client application 200 is instantiated by processor circuitry executing client application 200 instructions and/or configured to perform operations such as those represented by the flowchart of FIG. 3.

The example platform 204 is an environment where instructions may be executed. The platform 204 may be and/or include hardware, an operating system, software, etc. For example, the platform 204 may be Amiga, Chrome, Linux, macOS, Microsoft Windows, WSL 2, OpenVMS, and/or any other type of computing platform. The example platform 204 includes the example local API gateway 206 to forward API requests to one or more of the service container circuitry 212a-212n to execute a workload or portion of a workload. The example local API gateway 206 includes the example interface 208. The example interface 208 obtains request from the client application 200 via the system local network stack API address and forwards the request to one or more of the service container circuitry 212a-212n. Additionally, the example interface 208 obtains results from a workload execution from the example service container circuitry 212a-212n and forwards the results to the example client application 200 using a loopback interface (e.g., a URL corresponding to a system local network stack IP address such as 127.0.0.1).

The example request routing circuitry 210 of FIG. 2 determines which service container circuitry 212a-212n to execute a workload corresponding to an obtained API request. For example, the request routing circuitry 210 may analyze the URL and/or the header of the URL used for an obtained API request to determine which service constrainer circuitry 212a-212n is capable and/or available to execute the workload. Additionally or alternatively, the request routing circuitry 210 can use any routing technique and/or mapping technique to route a API request to execute a workload to corresponding service container circuitry 212a-212n.

The example metering and/or logging circuitry 211 of FIG. 2 meters and/or logs traffic through the local API gateway 206 and/or workload execution data performed by the service container circuitry 212a-212n. For example, the example metering and/or logging circuitry 211 may log obtained API requests, executed workload counts, etc. Additionally, the example metering and/or logging circuitry 211 may determine data related to the local execution of a workload (e.g., when a workload was executed, by which service container circuitry 212a, timing information corresponding to when the workload request was obtained, forwarded, and/or complete, error information corresponding to the execution of the workloads, etc.). The example metering and/or logging circuitry 211 stored the metering and/or logging data in memory, storage, a database, etc. In some examples, the metering and/or logging circuitry 211 may transmit (e.g., periodically, aperiodically, and/or based on a trigger) the metering data and/or logs to an external device. In this manner, the external device can use the data to optimize the platform 204 and/or the client application 200, perform error handling, track local execution of workloads across one or more computing devices, etc.

In some examples, the local API gateway 206, the interface 208, the request routing circuitry 210, and/or the metering and/or logging circuitry 211 is instantiated by processor circuitry executing local API gateway 206, interface 208, request routing circuitry 210, and/or metering and/or logging circuitry 211 instructions and/or configured to perform operations such as those represented by the flowchart of FIG. 3.

The example service container circuitries 212a-212n implement containers to be able to execute a workload. In some examples, each service container circuitry 212a-212n is capable of implementing a particular container for particular types of workloads. In some examples, the service container circuitry 212a-212n may implement multiple containers, where some service container circuitries may implementing the same type or different types of containers. After one of the service container circuitry 212a-212n executes a workload or a portion of a workload by implementing a container, the service container circuitry 212a-212n transmits the results of the executed workload to the example local API gateway 206. In this manner, the local API gateway 206 can forward the results to the example client application 200. In some examples, the service container circuitry 212a-212n is instantiated by processor circuitry executing service container circuitry 212a-212n instructions and/or configured to perform operations such as those represented by the flowchart of FIG. 3.

The example client circuitry 214 of FIG. 2 manages the example service container circuitry 212a. For example, the client circuitry 214 can determine which one or more of the service container circuitry 212a-212n will execute particular containers. Additionally, the client circuitry 214 receives inquiries as to the containers that are implemented by the service container circuitry 212a-212n. For example, the client application 200 may inquire whether a particular container is being implemented by one or more of the example service container circuitries 212a-212n. If the client circuitry 214 determines that the container is currently being implemented, the client circuitry 214 transmits a response that indicates that a container is available to execute a workload. If the client circuitry 214 determines that the container is not currently available, the client circuitry 214 transmits a response that indicates that a container is not available and the client circuitry 214 downloads the container to be executed on one of the service container circuitry 212a-212n so that the workload can be executed locally. In some examples, the service container circuitry 212a-212n is instantiated by processor circuitry executing service container circuitry 212a-212n instructions and/or configured to perform operations such as those represented by the flowchart of FIG. 3.

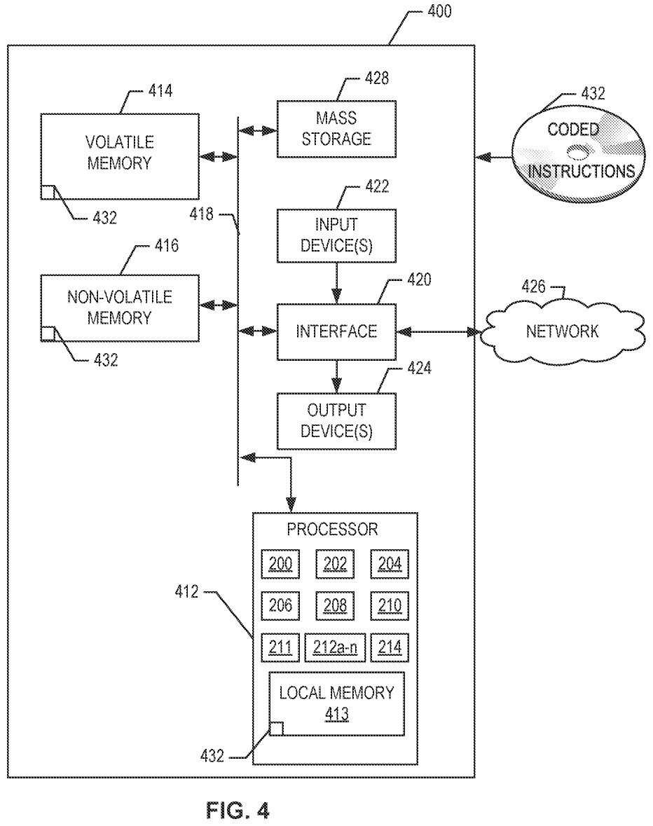

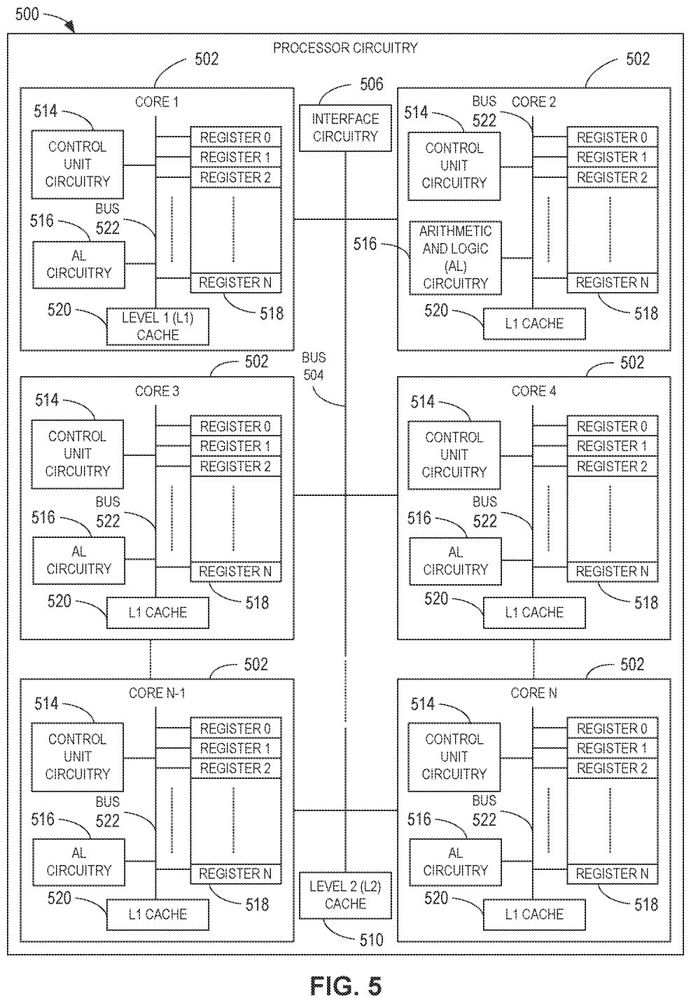

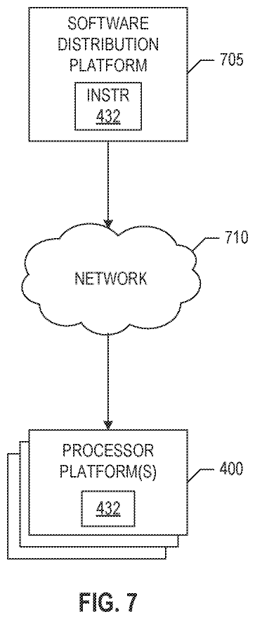

In some examples, the computing device 102 includes means for transmitting an API call. For example, the means for transmitting the API call may be implemented by the client application 200. In some examples, the computing device 102 includes means for identifying service container circuitry to execute a workload. For example, the means for identifying service container circuitry to execute a workload may be implemented by the local API gateway 206 and/or the request routing circuitry 210. In some examples, the computing device 102 includes means for utilizing a container to execute the workload. For example, the means for utilizing a container to execute the workload may be implemented by the service container circuitry 212a-212n. In some examples, the computing device 102 includes means for determining whether the container is locally available. For example, the means for determining whether the container is locally available may be implemented by the client circuitry 214. In some examples, the computing device 102 may be instantiated by processor circuitry such as the example processor circuitry 412 of FIG. 4. For instance, the computing device 102 may be instantiated by the example microprocessor 500 of FIG. 5 executing machine executable instructions such as those implemented by at least blocks 702, 704 of FIG. 7. In some examples, the computing device 102 may be instantiated by hardware logic circuitry, which may be implemented by an ASIC, XPU, or the FPGA circuitry 500 of FIG. 6 structured to perform operations corresponding to the machine readable instructions. Additionally or alternatively, the computing device 102 may be instantiated by any other combination of hardware, software, and/or firmware. For example, the computing device 102 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the computing device 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example client application 200, the example browser 202, the example platform 204, the example local API gateway 206, the example interface 208, the example request routing circuitry 210, the example metering and/or logging circuitry 211, the example service container circuitry 212a-212n, the example client circuitry 214, and/or, more generally, the example computing device 102 of FIG. 1, may be implemented by hardware alone or by hardware in combination with software and/or firmware. Thus, for example, any of the example client application 200, the example browser 202, the example platform 204, the example local API gateway 206, the example interface 208, the example request routing circuitry 210, the example metering and/or logging circuitry 211, the example service container circuitry 212a-212n, the example client circuitry 214, and/or, more generally, the example computing device 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example computing device 102 of FIG. 1 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed to configure processor circuitry to implement the example computing device 102 of FIG. 2, is shown in FIG. 3. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example computing device 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to service workloads locally without utilizing a TLS protocol. The machine readable instructions and/or the operations 300 of FIG. 3 begin at block 302, at which the example client application 200 requests a token from the example cloud server 106 of FIG. 1. For example, the client application 200 may utilize the browser 202 to transmit a token request using a network communication via the example network 104. The client application 200 may provide user credentials and/or any other information that can be used to verify an identity and/or authenticity of the computing device 102 (e.g., a root of trust key, an identifier, a password, an IP address, etc.). After the cloud server 106 authorizes the computing device 102 (e.g., based on the token request and/or credentials), the cloud server 106 transmits a token to the example computing device 102 to allow the computing device 102 to make requests to the cloud server 106 using the token.

At block 304, the example client application 200 obtains the token from the cloud server 106 via a network communication. The client application 200 may use the token to make requests to the example cloud server (e.g., to execute one or more workloads or portion of workload(s)). As described above, the client application 200 may determine that a workload or portion of a workload should be executed locally instead of at the cloud server 106. For example, the client application 200 may determine that the computing device 102 is capable and available to execute the workload and/or that the workload corresponds to sensitive and/or private data. Accordingly, in response to determining that a workload or a portion of a workload (e.g., a workload originally scheduled and/or tagged to be executed at the cloud server 106) should be executed locally, as opposed to at the cloud server 106, the example client application 200 transits an inquiry regarding whether container orchestration is available (block 306). For example, although the client application 200 may determine that the workload should be executed locally, the computing device 102 may not have a container downloaded to be able to execute the workload. Accordingly, the example client application 200 transmits the container orchestration inquiry to the example client circuitry 214 to determine if one of the service container circuitry 212a-212n can execute a container to execute the workload.

At block 308, after the example client circuitry 214 obtains the inquiry, the client circuitry 214 determines if container orchestration is available. For example, the client circuitry 214 determines if a container corresponding to the request has been deployed, downloaded, and/or implemented by one or more of the service container circuitry 212a-212n. If the example client circuitry 214 determines that container orchestration is available (block 308: YES), the example client circuitry 214 transmits a response to the client application 200 indicating that container orchestration is available (block 310). If the example client circuitry 214 determines that container orchestration is not available (block 308: NO), the example client circuitry 214 transmits a response to the client application 200 indicating that container orchestration is not yet available (block 312). After determining that container orchestration is not available, the example client circuitry 214 accesses, requests, and/or downloads the container (block 314). In this manner, the client circuitry 214 can let the client application 200 know when/if container orchestration is available for local execution of a workload. In some examples, the client circuitry 214 can transmit an alert, trigger, interrupt, etc. to the example client application 200 when the container is available. In some examples, the client application 200 may periodically re-inquire about the availability of the container orchestration.

At block 316, the example client application 200 determines if container orchestration is available (e.g., to execute the workload and/or a portion of the workload) based on the response from the client circuitry 214. If the example client application 200 determines that container orchestration is not available (block 316: NO), the example client application 200 uses the browser 202 to transmit an REST API cloud to the cloud server 106 (e.g., to execute a workload or a portion of the workload) (block 318). The example application 200 uses the browser 202 to submit a request with the token using a TLS protocol. In some examples, the client application 200 may, in response to determining that container orchestration is not available, the client application 200 may wait until container orchestration is available. The client application 200 may determine that container orchestration is available based on a subsequent inquiry and/or indication from the client circuitry 214. After block 318, control returns to block 306 (e.g., after a threshold amount of time) to transmit a subsequent container orchestration inquiry. In this manner, if the client application 200 determines that a workload can be executed locally, but the container is not yet available, the client application 200 can start the workload at the cloud-based server 106 and transition to local execution of the workload when the container is available locally.

If the example client application 200 determines that container orchestration is available (block 316: YES), the client application 200 transmits a REST API call to the local API gateway 206 using the example browser 202 based on a system local network stack IP address (block 320). For example, the client application 200 transmits a API call on a URL that corresponds to a system local network stack IP address. As described above, the use of the local API gateway 206 and the system local network stack IP address provides a secure channel for API calls without the cost, complexity, and security risk of a TLS protocol.

At block 322, the example interface 208 of the local API gateway 206 obtains the rest API call from the client application 200. At block 324, the example request routing circuitry 210 determines and/or selects one or more of the service container circuitries 212a-212n that is capable and/or available to implement a container corresponding to the API call (e.g., the container has been downloaded and/or implemented in the one or more of the service container circuitries). For example, the API call may correspond to execution of a particular workload that can be executed using a particular container. Accordingly, the example service container circuitry 212a-212n determines which service container circuitry(ies) 212a-212n implement the container corresponding to the workload that corresponds to the API call. The request routing circuitry 210 determines which container corresponds to the rest API call based on the URL, a header of the URL, and/or any other data provided by the example client application 200. For example, the URL, header of the URL and/or other data may identify a workload and/or container and/or may include data that is may be mapped to a particular workload and/or container. In this manner, the request routing circuitry 210 can determine which container corresponds to the API call and determine which service container circuitry(ies) implements the container.

At block 326, the example request routing circuitry 210 uses (e.g., instructs) the interface 208 to forward a workload execution request corresponding to the REST API call to the determined service container circuitry. After the service container circuitry 212a-n obtains the workload execution request, the service container circuitry 212a-n executes the workload or the portion of the workload. At block 328, the example interface 208 obtains results (e.g., an output) from the service container circuitry 212a-212n that executed the workload. At block 330, the example metering and/or logging circuitry 211 logs data corresponding to the local execution of the workload. For example, the metering and/or logging circuitry 211 may log that the workload was executed locally, a time of when the REST API was obtained, a time when the results were complete, the amount and/or type of resources used to execute the workload, etc. The example metering and/or logging circuitry 211 can store the logging and/or metering data in memory, storage, a database, etc. In some examples, the metering and/or logging circuitry 211 may transmit the logging and/or metering information stored in memory to an external device (e.g., for external tracking, error logging, troubleshooting, etc.). At block 322, the example request routing circuitry 210 uses (e.g., instructs) the interface 208 to forward the results (e.g., output) of the workload execution to the example client application 200.

FIG. 4 is a block diagram of an example processor platform 400 structured to execute and/or instantiate the machine readable instructions and/or the operations of FIG. 3 to implement the computing device 102 of FIG. 2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (VR) headset, etc.) or other wearable device, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs, microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements the example client application 200, the example browser 202, the example platform 204, the example local API gateway 206, the example interface 208, the example request routing circuitry 210, the example metering and/or logging circuitry 211, the example service container circuitry 212a-212n, and the example client circuitry 214 of FIG. 2.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 432, which may be implemented by the machine readable instructions of FIG. 3, may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may be a general purpose microprocessor (e.g., general purpose microprocessor circuitry). The microprocessor 500 executes some or all of the machine readable instructions of the flowchart of FIG. 3 to effectively instantiate the computing device 102 of FIG. 2 as logic circuits to perform the operations corresponding to those machine readable instructions. In some such examples, the computing device 102 of FIG. 2 is instantiated by the hardware circuits of the microprocessor 500 in combination with the instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 412 of FIG. 4. In this example, the processor circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowchart of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 600 may be structured to effectively instantiate some or all of the machine readable instructions of the flowchart of FIG. 3 as dedicated logic circuits to perform the operations corresponding to those software instructions in a dedicated manner analogous to an ASIC. Therefore, the FPGA circuitry 600 may perform the operations corresponding to the some or all of the machine readable instructions of FIG. 3 faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain machine readable instructions to configure the FPGA circuitry 600, or portion(s) thereof In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may be implemented by external hardware circuitry. For example, the external hardware 606 may be implemented by the microprocessor 500 of FIG. 5. The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations that may correspond to at least some of the machine readable instructions of FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowchart of FIG. 3 may be executed by one or more of the cores 502 of FIG. 5, a second portion of the machine readable instructions represented by the flowchart of FIG. 3 may be executed by the FPGA circuitry 600 of FIG. 6, and/or a third portion of the machine readable instructions represented by the flowchart of FIG. 3 may be executed by an ASIC. It should be understood that some or all of the computing device 102 of FIG. 2 may, thus, be instantiated at the same or different times. Some or all of the circuitry may be instantiated, for example, in one or more threads executing concurrently and/or in series. Moreover, in some examples, some or all of the computing device 102 of FIG. 2 may be implemented within one or more virtual machines and/or containers executing on the microprocessor.

In some examples, the processor circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 300, 432 of FIG. 3 and/or 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions 300, 432 of FIGS. 3 and/or 4, as described above. The one or more servers of the example software distribution platform 705 are in communication with an example network 710, which may correspond to any one or more of the Internet and/or any of the example network 104 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 300, 432 from the software distribution platform 705. For example, the software, which may correspond to the example machine readable instructions 300, 432 of FIGS. 3 and/or 4, may be downloaded to the example processor platform 400, which is to execute the machine readable instructions 432 to implement the computing device 102. In some examples, one or more servers of the software distribution platform 505 periodically offer, transmit, and/or force updates to the software (e.g., the example machine readable instructions 300, 432 of FIG. 3 and/or 4) to ensure improvements, patches, updates, etc., are distributed and applied to the software at the end user devices.

Example methods, apparatus, systems, and articles of manufacture to service workloads locally at a computing device are disclosed herein. Further examples and combinations thereof include the following: Example 1 includes an apparatus to service a workload locally, the apparatus comprising interface circuitry to obtain an indication that a container is locally available to execute a workload, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate application circuitry to, after determining that the container is locally available to execute the workload, transmit an application programming interface (API) call to local API gateway circuitry using a system local network stack Internet protocol (IP) address, the local API gateway circuitry to identify service container circuitry to execute the workload based on the API call, and the service container circuitry to utilize the container to execute the workload to generate an output, and the local API gateway circuitry to forward the output to the application circuitry.

Example 2 includes the apparatus of example 1, wherein the application circuitry is to transmit an inquiry to client circuitry corresponding to whether the container is locally available to execute the workload.

Example 3 includes the apparatus of example 2, wherein the processor circuitry is to perform at least one of the first operations, the second operations, or the third operations to instantiate the client circuitry to determine whether the container is locally available, and transmit the indication based on the determination.

Example 4 includes the apparatus of example 2, wherein the processor circuitry is to perform at least one of the first operations, the second operations, or the third operations to instantiate the client circuitry to download the container when the container is not available.

Example 5 includes the apparatus of example 1, wherein the API call is a first API call, the application circuitry to, after determining that the container is not locally available to execute the workload, transmit a second API call to a cloud-based server to execute a first portion of the workload at the cloud-based server.

Example 6 includes the apparatus of example 5, wherein the indication is a first indication, the application circuitry to, after determining that the container is locally available to execute the workload based on a second indication, transmit the API call to the local API gateway circuitry using the system local network stack IP address, the API call corresponding to local execution of a second portion of the workload.

Example 7 includes the apparatus of example 1, wherein the workload is scheduled to be executed at a cloud-based server.

Example 8 includes the apparatus of example 1, wherein the local API gateway circuitry is to select the service container circuitry based on a header of a URL used to transmit the API call, the URL corresponding to the system local network stack IP address.

Example 9 includes the apparatus of example 1, wherein the application circuitry is to transmit the API call without using at least one of a key, a token, or transport layer security.

Example 10 includes the apparatus of example 1, wherein the local API gateway circuitry is to log data corresponding to the local execution of the workload, and transmit the logged data to an external device.

Example 11 includes an apparatus to service a workload locally, the apparatus comprising at least one memory, machine readable instructions, and processor circuitry to at least one of instantiate or execute the machine readable instructions to after determining that a container is locally available to execute a workload, transmit an application programming interface (API) call to local API gateway circuitry using a system local network stack Internet protocol (IP) address, select service container circuitry that corresponds to the container to execute the workload based on the API call, and to execute the workload by implementing the container to generate an output, and forward the output to an application that sent the API call.

Example 12 includes the apparatus of example 11, wherein the processor circuitry is to determine whether the container is locally available to execute the workload, and download the container when the container is not locally available.

Example 13 includes the apparatus of example 11, wherein the API call is a first API call, the processor circuitry to after determining that the container is not locally available to execute the workload, transmit a second API call to a cloud-based server to execute a first portion of the workload at the cloud-based server, and after determining that the container is locally available to execute the workload, transmit the API call to the local API gateway circuitry using the system local network stack IP address, the API call corresponding to local execution of a second portion of the workload.

Example 14 includes the apparatus of example 11, wherein the workload is scheduled to be executed at a cloud-based server.

Example 15 includes the apparatus of example 11, wherein the processor circuitry is to select the service container circuitry based on a header of a URL used to transmit the API call, the URL corresponding to the system local network stack IP address.

Example 16 includes the apparatus of example 11, wherein the processor circuitry is to transmit the API call without using at least one of a key, a token, or transport layer security.

Example 17 includes the apparatus of example 11, wherein the processor circuitry is to log data corresponding to the local execution of the workload, and transmit the logged data to an external device.

Example 18 includes a non-transitory machine readable storage medium comprising instructions that, when executed, cause processor circuitry to at least cause transmission of an application programming interface (API) call to local API gateway circuitry using a system local network stack Internet protocol (IP) address based on a determination that a container is locally available to execute a workload, identify service container circuitry that can implement the container to execute the workload based on the API call, and utilize the service container circuitry to execute the workload to generate an output, and forward the output to an application corresponding to the API call.

Example 19 includes the computer readable medium of example 18, wherein the instructions cause the processor circuitry to determine whether the container is locally available to execute the workload, and download the container when the container is not locally available.

Example 20 includes the computer readable medium of example 18, wherein the API call is a first API call, the instructions to cause the processor circuitry to after determining that the container is not locally available to execute the workload, cause transmission of a second API call to a cloud-based server to execute a first portion of the workload at the cloud-based server, and after determining that the container is locally available to execute the workload, cause transmission of the API call to the local API gateway circuitry using the system local network stack IP address, the API call corresponding to local execution of a second portion of the workload.

Example 21 includes the computer readable medium of example 18, wherein the workload is scheduled to be executed at a cloud-based server.

Example 22 includes the computer readable medium of example 18, wherein the instructions cause the processor circuitry to select the service container circuitry based on a header of a URL used to transmit the API call, the URL corresponding to the system local network stack IP address.

Example 23 includes the computer readable medium of example 18, wherein the instructions cause the processor circuitry to cause transmission of the API call without using at least one of a key, a token, or transport layer security.

Example 24 includes an apparatus to service a workload locally, the apparatus comprising means for obtaining an indication that a container is locally available to execute a workload, and means for transmitting an application programming interface (API) call to forwarding means using a system local network stack Internet protocol (IP) address to after determining that the container is locally available to execute the workload, means for identifying execution means to execute the workload based on the API call, and the execution means to utilize the container to execute the workload to generate an output, and the forwarding means to forward the output to the means for transmitting.

Example 25 includes the apparatus or example 24, further including means for determining to determine whether the container is locally available to execute the workload, and download the container when the container is not locally available.

From the foregoing, it will be appreciated that example systems, methods, apparatus, and articles of manufacture have been disclosed that service workloads locally at a computing device. Disclosed systems, methods, apparatus, and articles of manufacture improve the efficiency of using a computing device by facilitating a secure and efficient technique for executing cloud-based workloads and/or portions of workloads locally at a computing device without the use of a TLS session/protocol. Examples disclosed herein including a local API gateway that enables an application to make API calls using a system local network stack to facilitate local execution of a workload without the need of a key exchanging session/protocol such as TLS. By leveraging the system local network stack (e.g., a localhost), examples disclosed herein provide a secure protocol for transmitting API requests that cannot be intercepted by a third party. Additionally, the use of a system local network stack is faster and more efficient than key exchange-based techniques due to a reduction in delay and/or cost of execution of the workloads due to network latency, reducing compute, network, and/or storage costs, etc. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to service a workload locally, the apparatus comprising:
interface circuitry to obtain an indication that a container is locally available to execute a workload; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
application circuitry to, after determining that the container is locally available to execute the workload, transmit an application programming interface (API) call to local API gateway circuitry using a system local network stack Internet protocol (IP) address;
the local API gateway circuitry to identify service container circuitry to execute the workload based on the API call; and
the service container circuitry to utilize the container to execute the workload to generate an output; and
the local API gateway circuitry to forward the output to the application circuitry.

2. The apparatus of claim 1, wherein the application circuitry is to transmit an inquiry to client circuitry corresponding to whether the container is locally available to execute the workload.

3. The apparatus of claim 2, wherein the processor circuitry is to perform at least one of the first operations, the second operations, or the third operations to instantiate the client circuitry to:
determine whether the container is locally available; and
transmit the indication based on the determination.

4. The apparatus of claim 2, wherein the processor circuitry is to perform at least one of the first operations, the second operations, or the third operations to instantiate the client circuitry to download the container when the container is not available.

5. The apparatus of claim 1, wherein the API call is a first API call, the application circuitry to, after determining that the container is not locally available to execute the workload, transmit a second API call to a cloud-based server to execute a first portion of the workload at the cloud-based server.

6. The apparatus of claim 5, wherein the indication is a first indication, the application circuitry to, after determining that the container is locally available to execute the workload based on a second indication, transmit the API call to the local API gateway circuitry using the system local network stack IP address, the API call corresponding to local execution of a second portion of the workload.

7. The apparatus of claim 1, wherein the workload is scheduled to be executed at a cloud-based server.

8. The apparatus of claim 1, wherein the local API gateway circuitry is to select the service container circuitry based on a header of a URL used to transmit the API call, the URL corresponding to the system local network stack IP address.

9. The apparatus of claim 1, wherein the application circuitry is to transmit the API call without using at least one of a key, a token, or transport layer security.

10. The apparatus of claim 1, wherein the local API gateway circuitry is to:
log data corresponding to the local execution of the workload; and transmit the logged data to an external device.

11. An apparatus to service a workload locally, the apparatus comprising:
at least one memory;
machine readable instructions; and
processor circuitry to at least one of instantiate or execute the machine readable instructions to:
after determining that a container is locally available to execute a workload, transmit an application programming interface (API) call to local API gateway circuitry using a system local network stack Internet protocol (IP) address;
select service container circuitry that corresponds to the container to execute the workload based on the API call; and
to execute the workload by implementing the container to generate an output; and
forward the output to an application that sent the API call.

12. The apparatus of claim 11, wherein the processor circuitry is to:
determine whether the container is locally available to execute the workload; and
download the container when the container is not locally available.

13. The apparatus of claim 11, wherein the API call is a first API call, the processor circuitry to:
after determining that the container is not locally available to execute the workload, transmit a second API call to a cloud-based server to execute a first portion of the workload at the cloud-based server; and
after determining that the container is locally available to execute the workload, transmit the API call to the local API gateway circuitry using the system local network stack IP address, the API call corresponding to local execution of a second portion of the workload.

14. The apparatus of claim 11, wherein the workload is scheduled to be executed at a cloud-based server.

15. The apparatus of claim 11, wherein the processor circuitry is to select the service container circuitry based on a header of a URL used to transmit the API call, the URL corresponding to the system local network stack IP address.

16. The apparatus of claim 11, wherein the processor circuitry is to transmit the API call without using at least one of a key, a token, or transport layer security.

17. The apparatus of claim 11, wherein the processor circuitry is to:
log data corresponding to the local execution of the workload; and
transmit the logged data to an external device.

18. A non-transitory machine readable storage medium comprising instructions that, when executed, cause processor circuitry to at least:
cause transmission of an application programming interface (API) call to local API gateway circuitry using a system local network stack Internet protocol (IP) address based on a determination that a container is locally available to execute a workload;
identify service container circuitry that can implement the container to execute the workload based on the API call; and
utilize the service container circuitry to execute the workload to generate an output; and
forward the output to an application corresponding to the API call.

19. The computer readable medium of claim 18, wherein the instructions cause the processor circuitry to:
determine whether the container is locally available to execute the workload; and
download the container when the container is not locally available.

20. The computer readable medium of claim 18, wherein the API call is a first API call, the instructions to cause the processor circuitry to:
after determining that the container is not locally available to execute the workload, cause transmission of a second API call to a cloud-based server to execute a first portion of the workload at the cloud-based server; and
after determining that the container is locally available to execute the workload, cause transmission of the API call to the local API gateway circuitry using the system local network stack IP address, the API call corresponding to local execution of a second portion of the workload.

21. The computer readable medium of claim 18, wherein the workload is scheduled to be executed at a cloud-based server.

22. The computer readable medium of claim 18, wherein the instructions cause the processor circuitry to select the service container circuitry based on a header of a URL used to transmit the API call, the URL corresponding to the system local network stack IP address.

23. The computer readable medium of claim 18, wherein the instructions cause the processor circuitry to cause transmission of the API call without using at least one of a key, a token, or transport layer security.

24. An apparatus to service a workload locally, the apparatus comprising:
means for obtaining an indication that a container is locally available to execute a workload; and
means for transmitting an application programming interface (API) call to forwarding means using a system local network stack Internet protocol (IP) address to after determining that the container is locally available to execute the workload;
means for identifying execution means to execute the workload based on the API call; and
the execution means to utilize the container to execute the workload to generate an output; and
the forwarding means to forward the output to the means for transmitting.

25. The apparatus or claim 24, further including means for determining to:
determine whether the container is locally available to execute the workload; and
download the container when the container is not locally available.
